(19) United States
(12) Patent Application Publication
(10) Pub. No.: US 2007/0143190 A1
(43) Pub. Date: Jun. 21, 2007

(54) Methods and systems to reserve wine from a cellar

(75) Inventors: Shilpa Banerjee, Prospect, KY (US); Angela R. Watson, Louisville, KY (US); Philip E. Back, Jeffersonville, IN (US); Rebecca Lynn Woodrow, Mt. Washington, KY (US); Brian Rickabaugh, Louisville, KY (US); Gregory L. Levinsky, Prospect, KY (US); Carol Leist, Louisville, KY (US)

Correspondence Address: JOHN S. BEULICK (13307), ARMSTRONG TEASDALE LLP, ONE METROPOLITAN SQUARE, SUITE 2600, ST. LOUIS, MO, 63102-2740, US

(73) Assignee: General Electric Company

(21) Appl. No.: 11/311,599

(22) Filed: Dec. 19, 2005

(51) Int. Cl. G06Q 30/00; G06F 7/00; G06Q 10/00

(52) U.S. Cl. 705/26; 700/214; 705/28

(57) ABSTRACT

A method for providing a cellar management system for a cellar includes providing a central server, operatively connecting a first user device with the central server via a network, and providing a database configured to contain specific information about each wine bottle input through the user device. The server is configured to allow a user to reserve a bottle of wine from the cellar via the user device such that the user device queues the reserved bottle and indicates the bottle has been reserved for removal.

### BACKGROUND OF THE INVENTION

This invention relates generally to cellar management systems, and more particularly, to a wine cellar management system and method for managing a wine cellar.

The popularity of wine has existed for many years. Today, there exists a variety of wine types, and the variety and complexity continues to increase. Consumption of wine is often an integral part of meals and for some people, is as important as the meal itself. Likewise, retail sales of wine and a personal collection of wine are becoming more popular throughout the world.

While the consumption and purchase of wine is widespread and popular throughout the world, numerous drawbacks exist in known wine cellar management systems. One such drawback arises as a result of the overwhelming variety of wine available for consumption, both the type of wine and the region from which the wine originates. For a wine connoisseur with a large collection, such as over one thousand bottles, it can be difficult and inefficient to manage the wine collection, i.e., add, remove, search, and analyze, the types of wines in the wine cellar. It is also difficult to manage and maintain the inventory of the wine stored in the wine cellar such that bottles of wine do not go bad from aging too long and bottles are not consumed before they have reached a proper age. In contrast to other consumables, wines are stored in cool, dark locations and are sold and bought by the bottle. As a result, the process of maintaining inventory by physically counting each bottle of available wine is a time consuming and undesirable task. In addition, frequent access to the wine cellar, e.g., to check the status of the wine collection, may adversely affect the conditions of the wine, such as, the temperature and humidity in the wine cellar.

### BRIEF DESCRIPTION OF THE INVENTION

In one aspect, a cellar management system is provided for managing a cellar that stores a plurality of wine bottles. Said system including a processor and a user device connected with the processor. The user device configured to input specific features of a bottle in the cellar thereby forming a database. Wherein a user can manage the cellar by inputting specific instructions into the user device which are processed by the processor.

In one aspect, a method for providing a cellar management system for a cellar includes providing a central server, operatively connecting a first user device with the central server via a network, and providing a database configured to contain specific information about each wine bottle input through the user device. The server is configured to allow a user to reserve a bottle of wine from the cellar via the user device such that the user device queues the reserved bottle and indicates the bottle has been reserved for removal.

In another aspect, a cellar management system is provided for remotely reserving a bottle of wine from a wine cellar. The system includes a first user device, a database containing specific features of every wine bottle, and a central server connected with the first user device via a network. The central server configured to process items within the database based on a user's instruction. The server is configured to enable a user to browse the contents of the wine cellar and select at least one desired bottle of wine for reservation through the first user device, and display on the first user device a symbol indicating the desired wine bottle has been reserved and is queued for removal.

In another aspect, a method is provided of remotely reserving a wine bottle from a wine cellar using a cellar management system. The system includes a first user device, a second user device, and a central server connected to both the first user device and the second user device via a network. The method includes inputting specific information of each wine bottle into the first user device thereby establishing at least one database, browsing the at least one database utilizing the second user device, and selecting at least one wine bottle for consumption. Wherein the second user device queues the bottle and indicates that the bottle has been reserved for removal.

### BRIEF DESCRIPTION OF THE DRAWINGS

FIG. 1 illustrates an exemplary perspective view of a wine cellar in accordance with one embodiment of the present invention;

FIG. 2 is a schematic view of a cellar management system applicable to the wine cellar shown in FIG. 1;

FIG. 3 is a screen shot of a main menus screen;

FIG. 4 is a screen shot of a Manage My Cellar screen that appears once manage my cellar button is selected from the screen shot shown in FIG. 3;

FIG. 5 is a screen shot depicting a left wall of a storage cellar and details regarding a particular selection;

FIG. 6 is a screen shot depicting a left wall of a tasting cellar and details regarding a particular selection;

FIG. 7 is a screen shot of a Detail screen obtained by selecting the Details button for the particular selection shown in FIG. 6;

FIG. 8 is a screen shot depicting a maturity of the cellar depicted in FIG. 6 for the wine bottles currently stored in the wine cellar;

FIG. 9 is a screen shot of a Detail list screen obtained by selecting a quantity cell in the screen shot depicted in FIG. 8;

FIG. 10 is a screen shot depicting a maturity timeline of the cellar depicted in FIG. 6 for the wine bottles currently stored in the wine cellar;

FIG. 11 is a screen shot of a screen that appears as a result of selecting add bottles button shown in FIG. 3;

FIG. 12 is a screen shot that includes a plurality of drop down menus that assist a user with populating the database with the appropriate information;

FIG. 13 is a screen shot that allows the user to print a bar-coded tag for the bottle so the bottle can be stored in the cellar; and

FIG. 14 is a screen shot of a remove bottle screen that allows a user to remove a bottle from the data stored in the system depicted in FIG. 2.

### DETAILED DESCRIPTION OF THE INVENTION

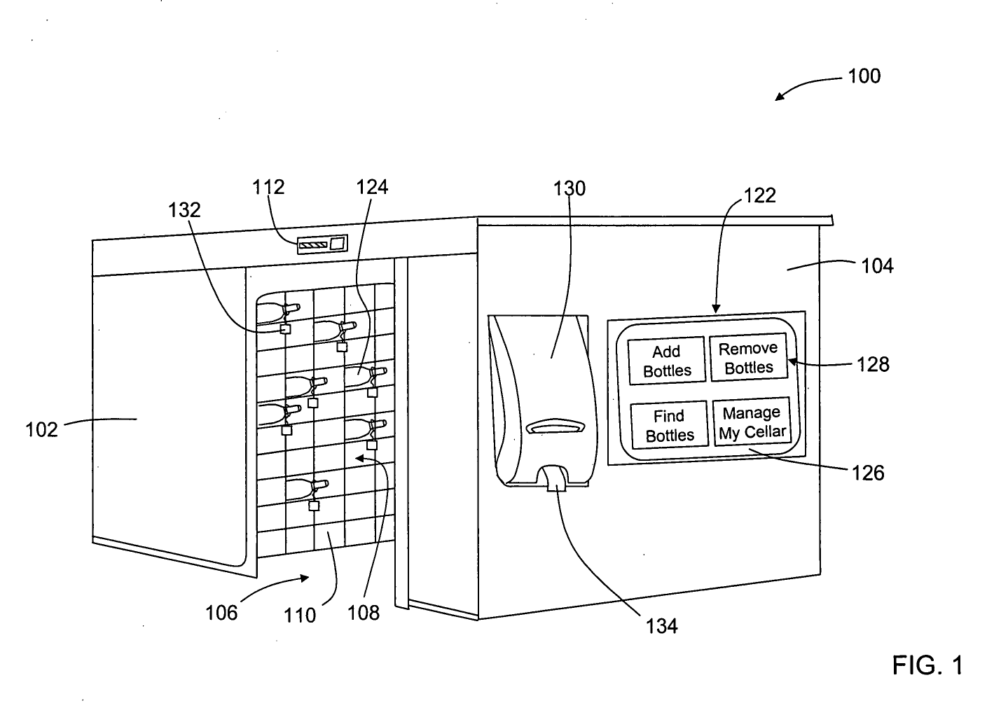

FIG. 1 illustrates a perspective view of a wine cellar 100 in which the present invention may be practiced. In one exemplary embodiment, wine cellar 100 includes only a storage cellar having of a plurality of wood racked walls. In another embodiment, wine cellar 100 includes a tasting cellar equipped with both a tasting area and a storage area. Of course it should be recognized that cellar 100 could be customized to suit the individual tastes of those that will be using it. In the exemplary embodiment, wine cellar 100 is fabricated from stainless steel and insulating materials, such as high-density foam, to ensure a predetermined temperature and energy-efficient performance. Wine cellar 100 may be located in a recreation room, or in other living spaces, such as a large pantry, library, loft-style kitchen, or a casual dining area. Alternatively, cellar 100 may be located in a basement or other room contained below ground level. It is recognized, however, that the benefits of the present invention are equally applicable to other types of wine cellars and other wine storage containers. Consequently, the description set forth herein is for illustrative purposes only and is not intended to limit the invention in any aspect.

In the exemplary embodiment, wine cellar 100 has a cube shape and includes a front wall 102, a rear wall (not shown), a left sidewall (not shown), and a right sidewall 104. An entranceway 106 is defined through front wall 102 for accessing an interior of cellar 100. A door (not shown) is used to seal the interior of cellar 100 and separate it from the ambient environment such that a controlled environment exists within cellar 100. The interior of cellar 100 includes a plurality of racks 108 mounted to at least one inside wall. In the exemplary embodiment, racks 108 are moisture-resistant redwood racks mounted to every inside wall. A plurality of cells 110 are defined in racks 108 for single bottle, double bottle, and triple bottle storage, while also accommodating magnum bottles and crates. A thermostat 112 is positioned on one of the walls to control temperature, allowing adjustment between 40 and 70 degrees Fahrenheit, while maintaining ideal humidity conditions.

A cellar management system 120 includes a first user input terminal, or user device 122, such as a personal computer, to efficiently manage a large quantity of wine bottles 124 received within respective cells 110 of cellar 100. First user device 122 includes a touch screen 126 having a plurality of main menus 128 displayed thereon as well as drop-down menus (not shown) to assist in the proper management of the inventory of wine cellar 100. Main menus 128 and the drop-down menus allow the user to utilize a pre-loaded database to classify each bottle entered into cellar management system 120 and track it during its stay in cellar 100, as will be described in more detail hereinafter.

A printer 130 is operatively coupled to first user device 122 for printing a bar-code tag or label 132 that contains specific information regarding each wine. Label 132 is then affixed to a reusable plastic tag, which is placed on a particular bottle. Each bottle within cellar 100 includes such a tag attached thereto for easy identification in wine cellar 100. A scanner 134 is operatively coupled to first user device 122 and is configured to scan bar-code label 132 and display specific information about each wine bottle on a display terminal of first user device 122. In the exemplary embodiment, scanner 134 is integrally formed with printer 130 and both printer 130 and scanner 134 are positioned adjacent to first user device 122. In an alternative embodiment, first user device 122, printer 130, and scanner 134 are integrated into a single unit.

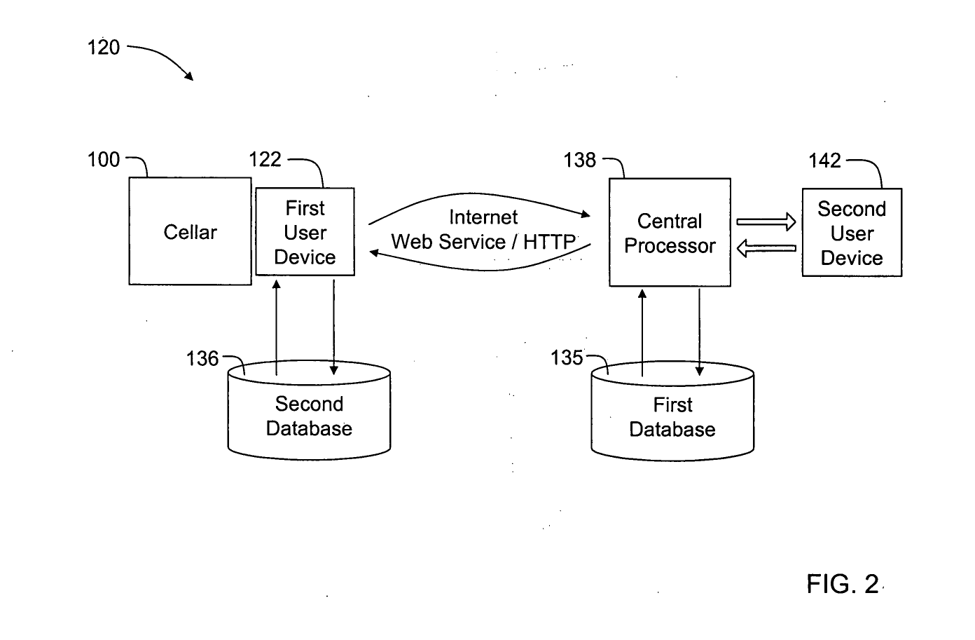

FIG. 2 is a schematic view of cellar management system 120 shown in FIG. 1. Cellar management system 120 includes a first database 135 for storing data such as specific information about each wine bottle for the entire inventory within wine cellar 100. A second database 136 is located locally to first user device 122 and is accessible by first user device 122 for storage of data therein. Cellar management system 120 also includes a central processor 138, such as a central server, operatively coupled to first user device 122 via a network which is a high-speed Internet connection or other similar network. Central processor 138 is also coupled to first database 135 and is configured to display information stored in database 135 on the display terminal of first user device 122 regarding the inventory within wine cellar 100. In one embodiment, first database 135 is located locally to central processor 138. First user device 122, in one embodiment, is a user interface that includes a display portion, such as a screen, and an input portion, such as a keyboard. In another embodiment, the display portion and the input portion are combined and form a touch screen operable by the user.

System 120 also includes a second user device 142 operatively coupled to central processor 138 via a high-speed Internet connection. In the exemplary embodiment, second user device 142 is remote from wine cellar 100 and both first user device 122 and second user device 142 are configured to allow a user to actively manage the wine bottles in wine cellar 100. System 120 is configured such that first user device 122 accesses second database 136 and stores data to second database 136. Central processor 138 accesses first database 135 and stores data to first database 135. Databases 135 and 136 are synchronized so that all information is current and accurate in both databases 135, 136. The synchronizations occur when first user device 122 is connected to central processor 138 via a network. In one embodiment, the synchronizations occur on a periodic basis, such as every 20 minutes, or nightly. Alternatively, the synchronizations are triggered by activity occurring in one of databases 135, 136.

Second user device 142 accesses first database 135 through central processor 138. Thus, when changes are made to the data via second user device 142, central processor 138 stores the changes on first database 135, and when changes are made to the data via first user device 122, those changes are stored in second database 136. Once the synchronization process occurs, the changes stored in first database 135 are also stored in second database 136 and the changes stored in second database 136 are stored in first database 135.

In an alternative embodiment, system 120 is not connected to a network and accordingly runs only at the cellar local level. In this embodiment, first user device 122 accesses only second database 136. The information used to run the system is contained within device 122 and database 136.

In use, system 120 allows a user to view an image of wine cellar 100 through at least one of first user device 122 and second user device 142. In addition, system 120 enables the user to add and/or remove a wine bottle from databases 135, 136, search for a particular bottle that satisfies a given criteria, and reserve a bottle for immediate use.

In the exemplary embodiment, software is used to create an image of cellar 100. The user is prompted by system 120 to enter configuration of a wine cellar such as cellar 100. In one embodiment, the cell structure is set by system 120. Alternatively, the requested information includes items such as number of walls, bin size, number of rows and number of columns. After the user inputs the requested information, a replica is generated for each wine rack 108 and an image can then be displayed on first user device 122. Once the image is generated, a user can modify the image to more accurately reflect the true configuration of cellar 100.

As explained in more detail below, the user can view every wall in their cellar, and every storage space on the wall. The user can move from one wine cell to another by selecting the cell, or by using a navigator on the screen to view more details. The user can easily manage the wine bottles by utilizing the generated image of each inside wall of the wine cellar. The user can track a vintage of the wine, compare the vintage to a known life span for the particular type of wine, and indicate the status of each bottle within cellar management system 120. The user knows the location of wine bottles based on different symbols, which indicate specific types of the wine.

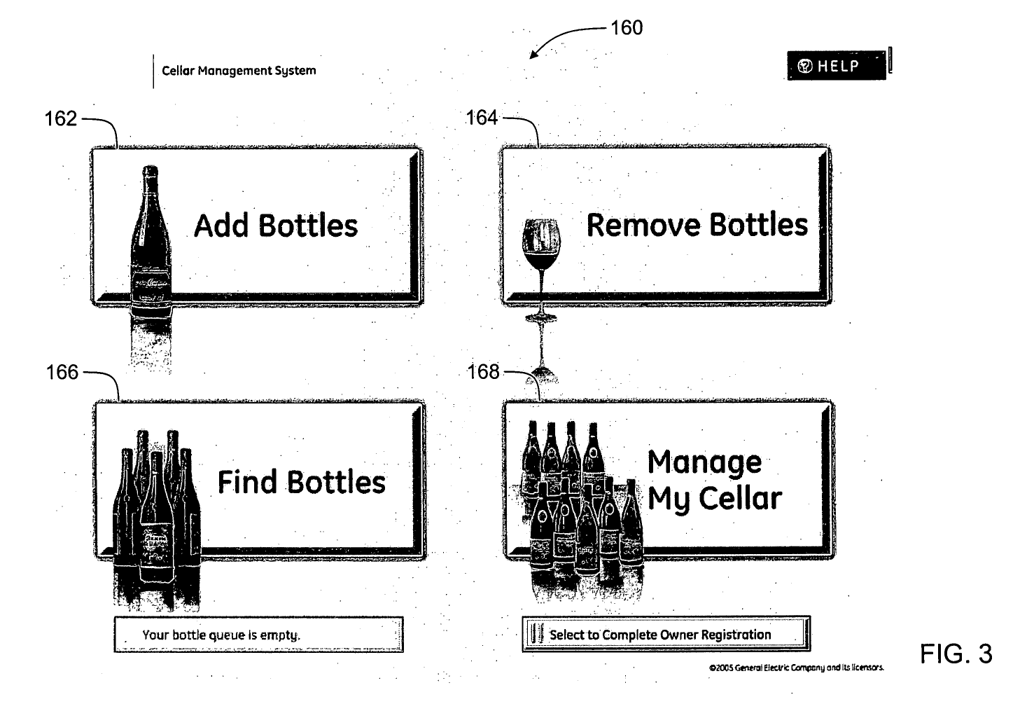

FIG. 3 is a screen shot 160 of a main menus screen. Screen shot 160 includes an add bottles button 162, a remove bottle button 164, a find bottles button 166, and a manage my cellar button 168. Selection of any of buttons 162, 164, 166, 168 brings up a respective screen for the task to be performed.

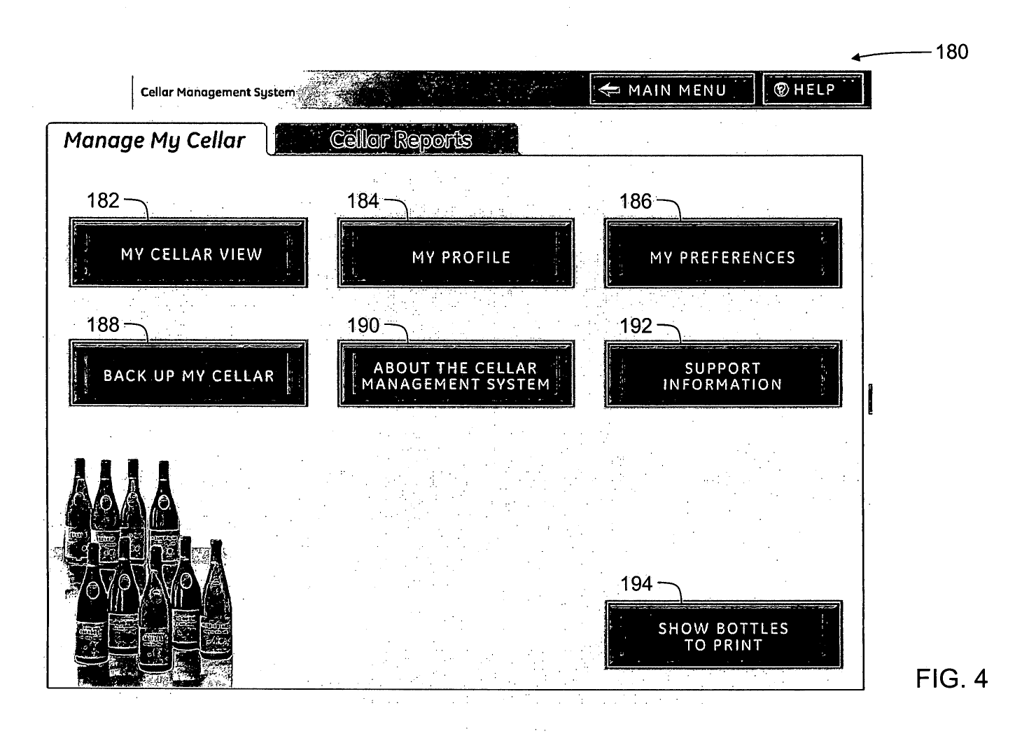

FIG. 4 is a screen shot 180 of a Manage My Cellar screen that appears once manage my cellar button 168 is selected from screen shot 160. Screen shot 180 enables the user to actively manage the inventory contained within cellar 100 (shown in FIG. 1). Screen shot 180 includes a my cellar view button 182, a my profile button 184, a my preferences button 186, a back up my cellar button 188, an about the cellar management system 190 and a support information button 192. In addition, screen shot 180 includes a show bottles to print button 194.

More specifically, the user can select a left wall button to view wine bottles arranged on a left inside wall of wine cellar 100 and select a right wall button to view wine bottles arranged on a right inside wall of wine cellar 100.

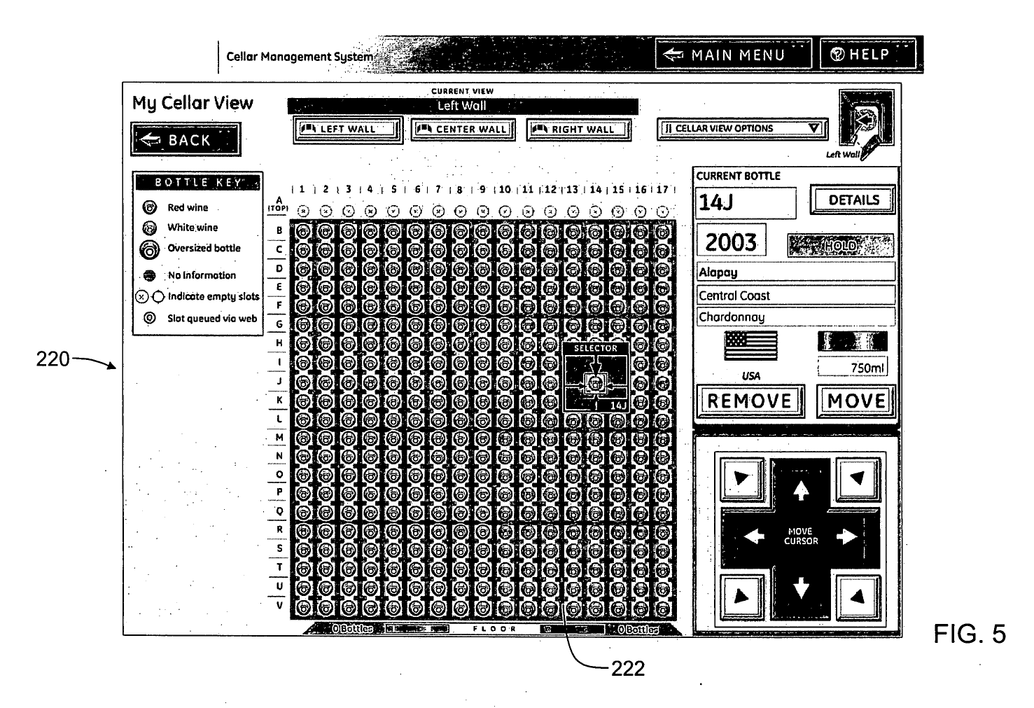

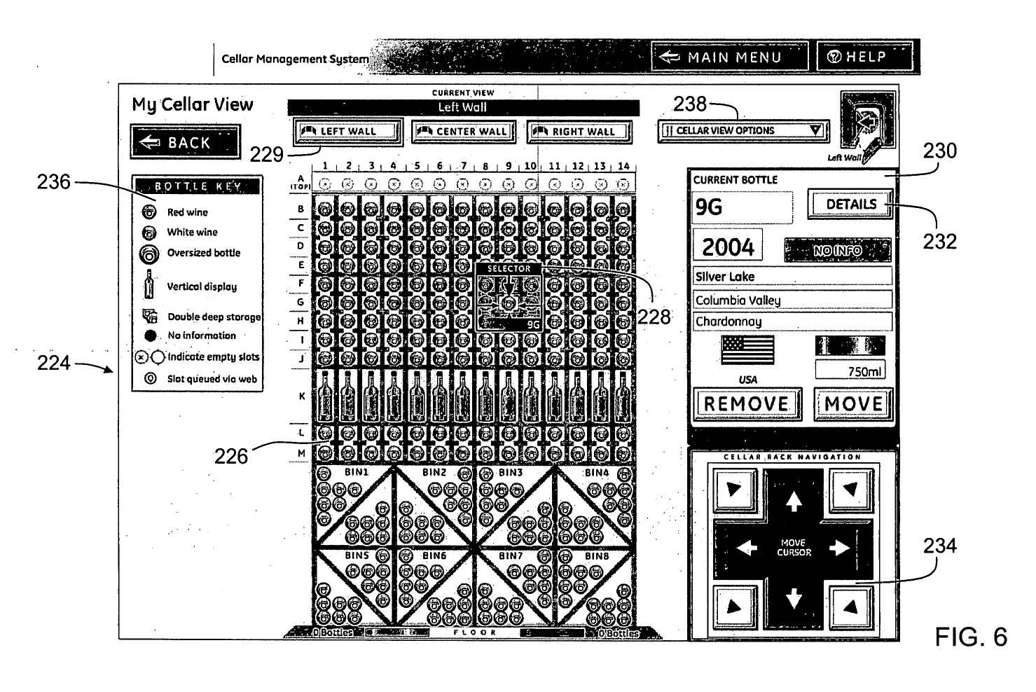

FIG. 5 is a screen shot 220 depicting a left wall 222 of a storage cellar and details regarding a particular selection. Screen shot 220 appears when my cellar view button 182 is selected from screen shot 180. FIG. 6 is a screen shot 224 depicting a left wall 226 of a tasting cellar and details regarding a particular selection. Screen shot 224 appears when my cellar view button 182 is selected from screen shot 180 and cellar 100 (shown in FIG. 1) includes a tasting cellar. As shown in screen shots 220, 224, a left wall of the cellar includes a plurality of cells filled with either a red wine or a white wine. As shown in FIG. 5, a cursor or selector 228 is located on a specific position, overlapping with a symbol of a wine bottle after the user selects a left wall button 229. Selection of either a center wall button or a right wall button will change the view to the appropriate selection. A display portion 230 on the right side of screen shot 224 indicates preliminary data regarding the wine bottle selected with selector 228. Such data includes information such as, position, vintage, volume, maturity status, region, and country of origin. For further detailed information, a details button 232 within display portion 230 is provided for the user to obtain additional information regarding the selection as will be described herein below. A navigator 234 is provided under display portion 230 to allow the user to graphically move from one cell to another by selecting the cell, using navigator 234. In addition, a bottle key 236 is included on screen shot 224 and provides information regarding the symbols used in FIG. 6.

In the exemplary embodiment, if the user selects a cellar view options button 238 above display portion 230, the user is able to configure the data to be presented in a particular manner, such as view by color and/or view by maturity. In addition, a report about the wine in cellar 100 can be run. In one embodiment, such a report is used to generate a graph which enables a user to know the status of the wine bottles in cellar 100.

In addition, system 120 is configured to determine the amount of empty space contained in cellar 100 and the age of the wine compared to the optimum age for drinking each particular bottle. The space determination accounts for cells sized to include multiple bottles of wine. In one embodiment, the empty space is determined utilizing an algorithm.

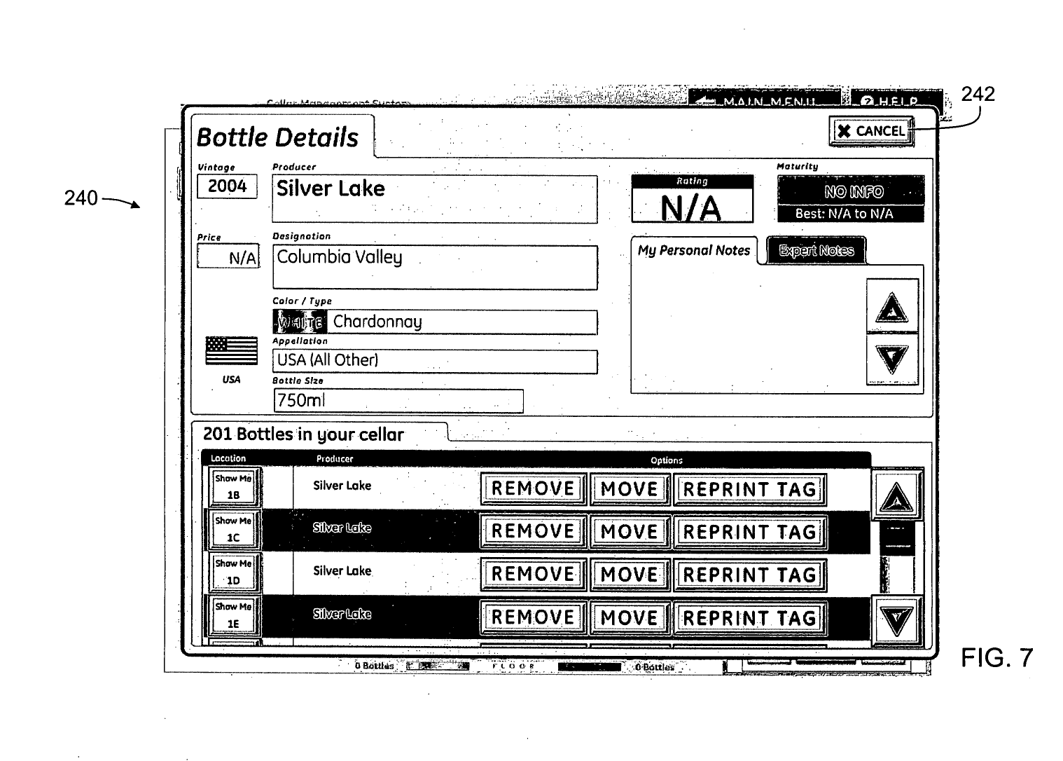

FIG. 7 depicts a screen shot 240 displayed after details button 232 (shown in FIG. 6) is selected. Details screen shot 240 includes details regarding the particular wine selected by the user. Such details include one or more of vintage, producer, price, designation, color/type, appellation, and bottle size. In addition, there is an area that may include personal notes and/or expert notes regarding the wine. There is also a rating that a user can attach to the bottle as well as maturity information. In the exemplary embodiment, the user inputs the data regarding the maturity, the rating, and the expert notes. In an alternative embodiment, system 120 populates one or more of these fields with the appropriate information. Also, there is included on screen shot 240 a listing of each bottle that meets pre-selected criteria of the selection. In the exemplary embodiment, the criteria include all bottles produced by a particular producer (Silver Lake). Selection of a cancel button 242 returns the user to the previously viewed screen (screen shot 220).

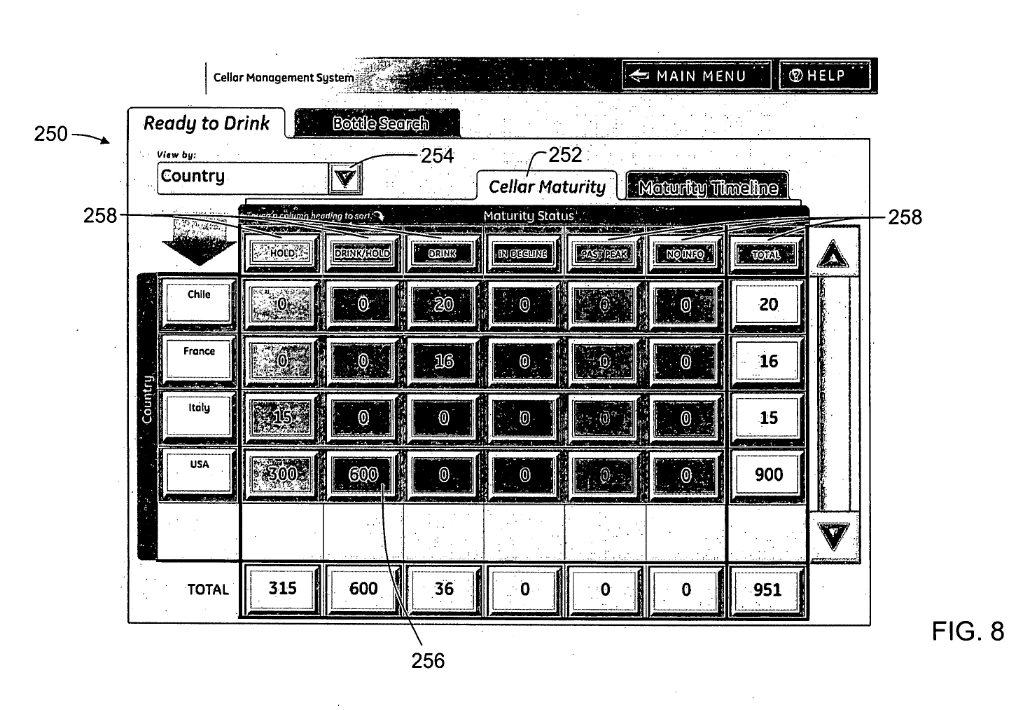

FIG. 8 is a screen shot 250 depicting a maturity of the cellar depicted in FIG. 6 for wine bottles currently stored in cellar 100. A user is able to view screen shot 250 by selecting find bottles button 166 on screen shot 160 shown in FIG. 3. Screen shot 250 is utilized to find a particular bottle of wine that is appropriately aged for drinking. Screen shot 250 is also utilized to actively manage the wines within cellar 100. For example, if too many bottles are listed in the drink, in decline, or past peak blocks, then the user can make an informed decision regarding whether to sell the excess bottles or consume the wine from those bottles. Such features guide the user towards drinking bottles of wine at the right maturity level to be consumed. More specifically, when the user selects a cellar maturity tab 252, screen shot 250 shows the maturity status of the wine in wine cellar 100 and other specific information regarding the wine.

In use, the user can search for a red wine made in France before February 1980. After find bottles button 166 (shown in FIG. 3) is selected, a search frame and a search option are displayed on the screen of the user device being utilized. The user inputs key words, such as, red wine, France, 1980, and selects the search button. The user device processes the appropriate database to identify wine bottles which meet criteria input by the user. This search function also allows the user to add a wine to their own collection.

In the exemplary embodiment, the user can reserve a wine for consumption in wine cellar 100 from a remote location using second user device 142. To do this, the user browses the computer-generated image of each inside wall of wine cellar 100 to determine which wine to select. Alternatively, a desired bottle can be found and reserved by inputting one or more keywords with a keyboard. Then, the user selects the listed wine icon on the screen of the computers. As such, second user device 142 queues the bottle and indicates the bottle has been reserved for removal. This information is then stored in first database 135 so the information can be accessed from any user device. Additionally, system 120 allows users to back up their database containing the local inventory data.

Additionally, wine cellar 100 can be managed remotely through a web site. Other remote user devices or similar terminals can be connected to central processor 138 via a network to access database 135 of system 120. A wireless terminal, such as a cell phone, a personal digital assistant, or a laptop computer can also be used to access database 135 and thereby manage wine cellar 100 via a wireless network.

As shown in FIG. 8, screen shot 250 includes a matrix that drills down into categories of wine at a high level. In the exemplary embodiment, a user selects a descriptive category 254 and system 120 then builds the matrix according to that selection. For example, the user has selected country and accordingly, one axis of the matrix is country while the other axis is the maturity status. Other categories that can be selected include type of wine, country, vintage, appellation, and producer. If the user selects one of header buttons 258, such as “drink”, the set of data is sorted based on the numbers under that header button, i.e., by the integer in the column. If it is desired to obtain more information regarding the information contained in a particular matrix cell 256, the user simply selects the cell. A detail screen 260, similar to that shown in FIG. 7 is then displayed and a listing of all bottles that satisfy a given criteria are shown.

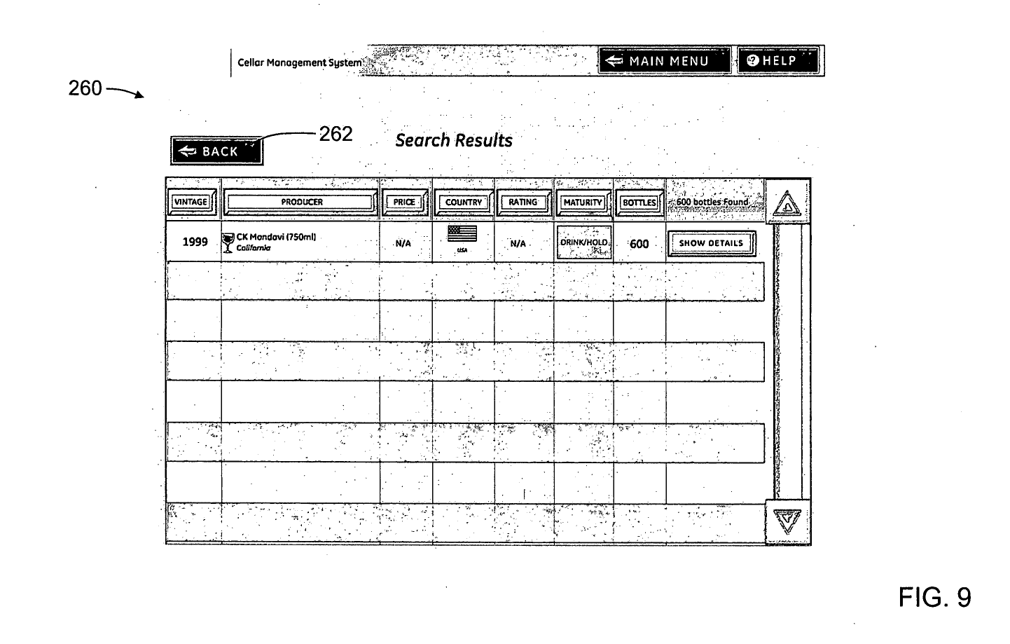

FIG. 9 depicts additional details regarding the wines contained within the cell previously selected from FIG. 8. The details include information such as vintage, producer, price, country, rating, maturity, and number of bottles. The user moves back to the previous screen by simply selecting a back button 262.

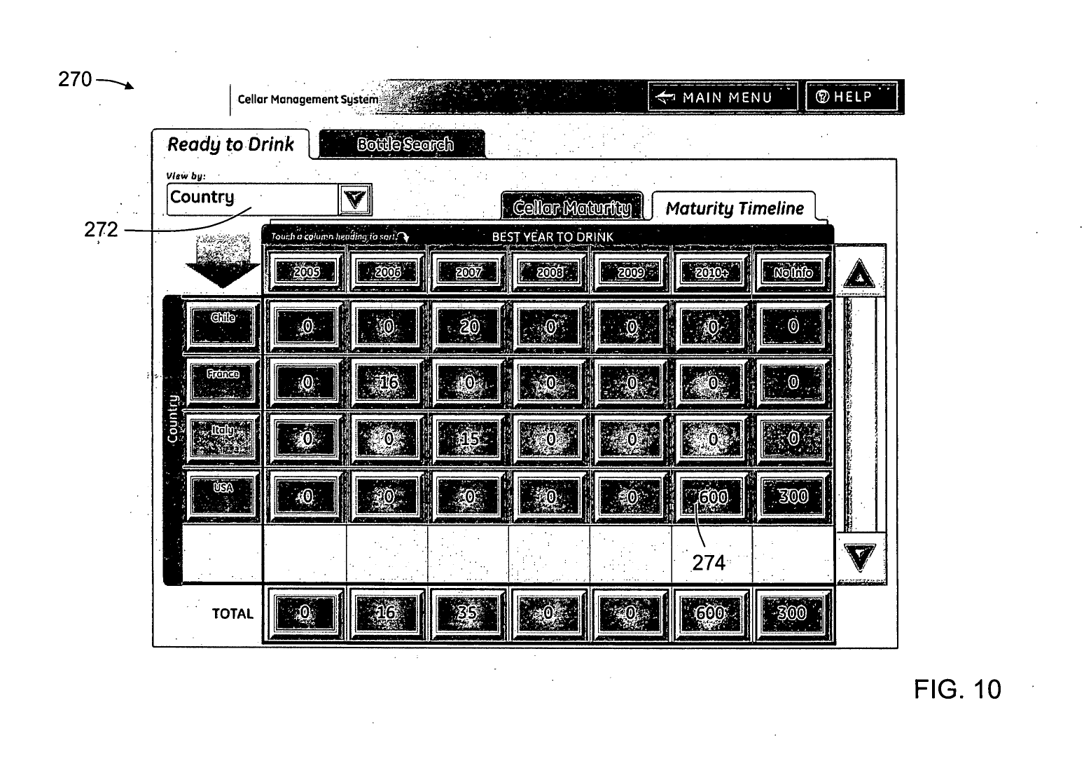

FIG. 10 is a screen shot 270 depicting a maturity timeline of the cellar depicted in FIG. 6 for the wine bottles currently stored in cellar 100. Screen shot 270 includes a listing by year of wines that are ready to be consumed. In the exemplary embodiment, a user selects a grouping category 272 and system 120 then builds the matrix according to that selection. For example, the user has selected country and accordingly, one axis of the matrix is country while the other axis is the best year to drink timeline. Other categories that can be selected include type of wine, country, vintage, appellation, and producer. If it is desired to obtain more information regarding the information contained in a particular matrix cell 274, the user simply selects the cell. A detail screen 260, such as that shown in FIG. 9 is then displayed.

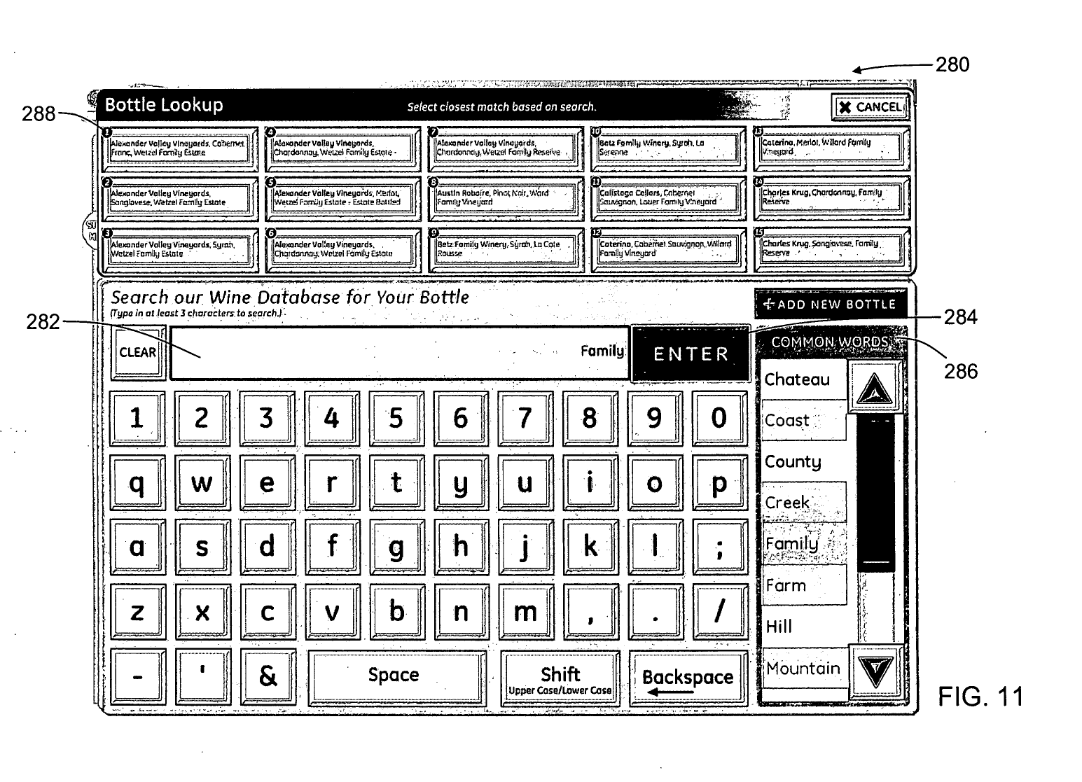

FIG. 11 is a screen shot 280 of a screen that appears as a result of selecting add bottles button 162 shown on screen shot 160 in FIG. 3. A user can enter information into a text box 282 and then select an enter button 284. Alternatively, the user can select one of the common words 286 listed on a right side of screen shot 280. System 120 will then populate box 282 with the selected word and the system will search database 136 for bottle descriptions that match the word. In another alternative, the user selects one of the buttons along a top of screen shot 280, such as Alexander Valley Vineyards 288. In the exemplary embodiment, the user input device is a touch screen and the user simply touches the appropriate locations on the screen to input the indicated information.

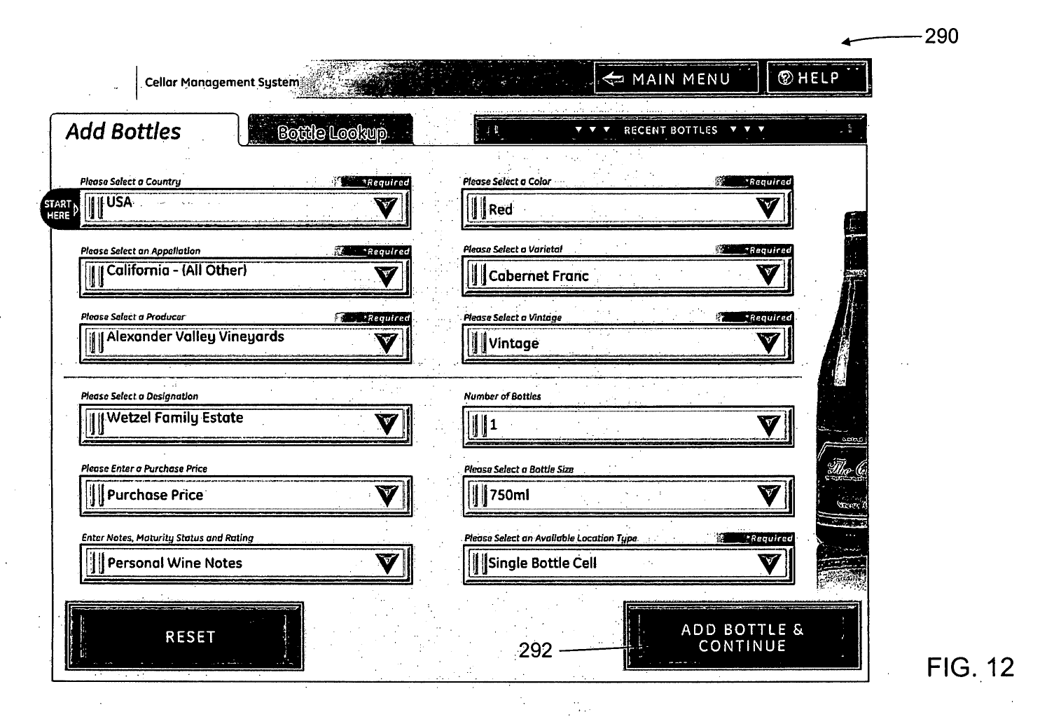

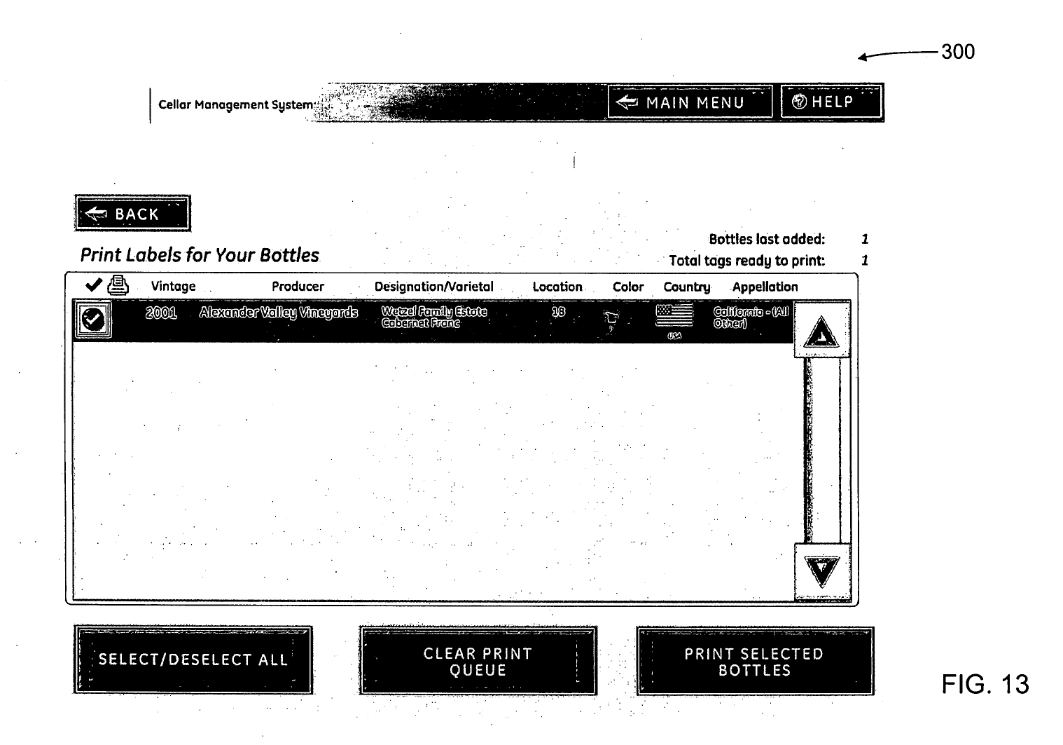

Selection of button 288 causes system 120 to display screen shot 290 as shown in FIG. 12. Screen shot 290 includes a plurality of drop down menus that assist a user with populating database 136 with the appropriate information. Once the appropriate information is included, the user selects add bottle & continue button 292. Upon completion of the addition of the information, the user is directed to screen shot 300 as shown in FIG. 13. Screen shot 300 allows the user to print a bar-coded tag for the bottle so the bottle can be stored in cellar 100. The printed tag is placed over a neck of the bottle and the bottle is stored in its proper cell.

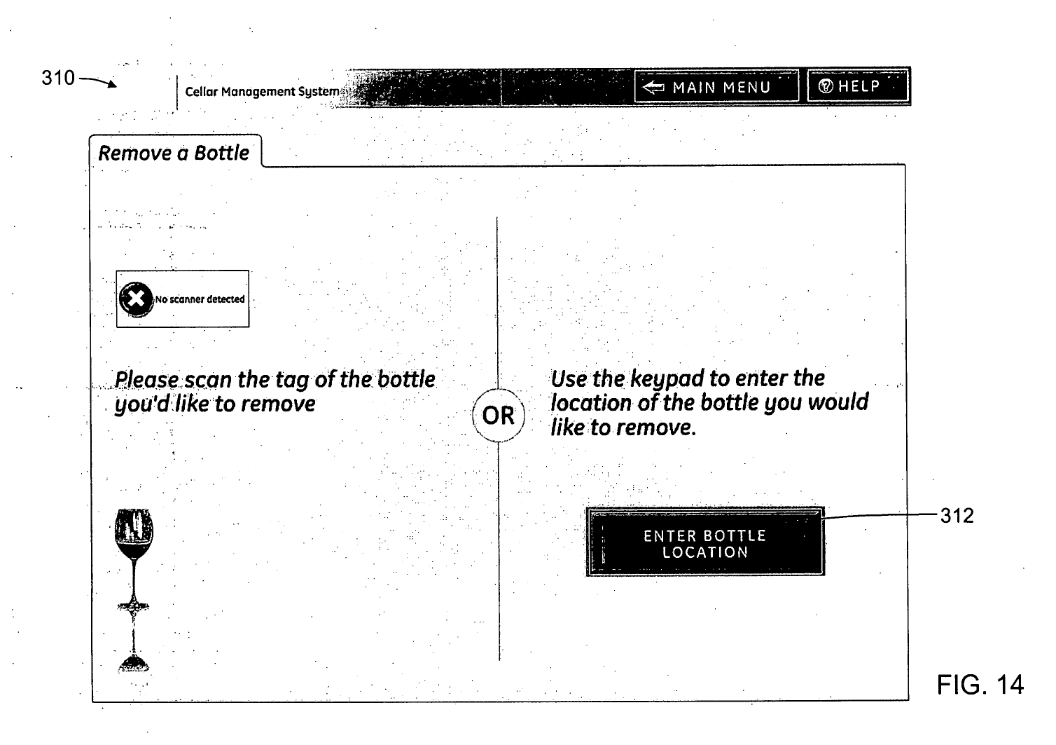

FIG. 14 is a screen shot 310 of a remove bottle screen that allows a user to remove a bottle from the data stored in system 120 (shown in FIG. 2). Screen shot 310 appears once the user selects remove bottles button 164 from screen shot 160 shown in FIG. 3. There are at least two ways to remove a bottle from the inventory of cellar 100 and system 120. One approach utilizes the touch screen on first user device 122 (shown in FIG. 2) to enter the location of the bottle to be removed. An enter bottle location button 312 is selected by the user to access a screen that accepts the information specific to the bottle being removed. Selection of a remove bottles option instructs system 120 (shown in FIG. 2) to delete the desired bottle record from database 136 (shown in FIG. 2), if first user device 122 is used, and from database 135 if second user device 142 is used. The second approach utilizes bar-code scanner 134 (shown in FIG. 1) to scan bar-coded tag 132 (shown in FIG. 1) of the bottle to be removed. Tag 132 is removed from the neck of the removed bottle and is positioned such that scanner 134 can detect the information contained on tag 132. Once scanner 134 scans bar-coded tag 132, first user device 122 deletes the bottle record from database 136. This deletion is then recorded in database 135 once first user device 122 is connected to central processor 138 through a network.

The cellar management system described above generates an image of the wine cellar so that the contents of the cellar can be managed by the user. This management can occur either at the cellar or remotely through a network. The system can determine the empty space within the cellar and the status of each bottle of wine with regard to when the bottle is properly aged for drinking. Bottles can be reserved through the user devices and a prompt can be generated by the system to remind the user that a particular bottle has been reserved.

While the invention has been described in terms of various specific embodiments, those skilled in the art will recognize that the invention can be practiced with modification within the spirit and scope of the claims.

1. A method for providing a cellar management system for a cellar, said method comprising:
providing a central server;
operatively connecting a first user device with the central server via a network; and
providing a database configured to contain specific information about each wine bottle input through the user device, wherein the server is configured to allow a user to reserve a bottle of wine from the cellar via the user device such that the user device queues the reserved bottle and indicates the bottle has been reserved for removal.

2. A method in accordance with claim 1 wherein operatively connecting a user device with the central server via a network comprises remotely connecting the user device with the central server via the network.

3. A method in accordance with claim 1 wherein operatively connecting a user device with the central server via a network comprises connecting the user device with the central server via a high-speed Internet connection.

4. A method in accordance with claim 1 wherein operatively connecting a user device with the central server via a network comprises providing a touch screen having a plurality of main menus and drop-down menus.

5. A method in accordance with claim 1 further comprising operatively coupling a printer to the user device, wherein the printer is configured to print specific information of each bottle.

6. A method in accordance with claim 1 further comprising operatively coupling a scanner to the network.

7. A method in accordance with claim 2 further comprising operatively connecting a second user device with the central server via a network such that the user can access the database from either the first user device or the second user device, wherein the second user device is located at the cellar.

8. A cellar management system for remotely reserving a bottle of wine from a wine cellar, said system comprising:
a first user device;
a database containing specific features of every wine bottle; and
a central server connected with said first user device via a network, said central server configured to process items within said database based on a user's instruction; wherein said server configured to enable a user to browse the contents of the wine cellar and select at least one desired bottle of wine for reservation through said first user device, and display on said first user device a symbol indicating the desired wine bottle has been reserved and is queued for removal.

9. A cellar management system in accordance with claim 8 wherein said first user device comprises a touch screen.

10. A cellar management system in accordance with claim 8 further comprising a printer operatively coupled to said first user device, said printer configured to print specific information about each bottle on a tag.

11. A cellar management system in accordance with claim 10 further comprising a scanner operatively coupled to said first user device, said scanner configured to scan the tag for displaying the specific information about each bottle

12. A cellar management system in accordance with claim 8 wherein said first user device is located at said cellar, said system further comprising a second user device connected with said server and located remote from the wine cellar.

13. A cellar management system in accordance with claim 12 wherein said system configured to add a bottle of wine to the inventory utilizing said first user device.

14. A cellar management system in accordance with claim 12 wherein said system configured to provide a reminder to the user through at least one of said first user device and said second user device that a particular bottle has been queued for removal from said cellar.

15. A method of remotely reserving a wine bottle from a wine cellar using a cellar management system which includes a first user device, a second user device, and a central server connected to both the first user device and the second user device via a network, said method comprising:
inputting specific information of each wine bottle into the first user device thereby establishing at least one database;
browsing the at least one database utilizing the second user device; and
selecting at least one wine bottle for consumption, wherein the second user device queues the bottle and indicates that the bottle has been reserved for removal.

16. A method in accordance with claim 15 wherein the at least one database comprises a first database and a second database, said method further comprising synchronizing data from the first database to the second database after specific information of each wine bottle is input with the first user device.

17. A method in accordance with claim 15 wherein the first user device located at the cellar and the second user device located remote from the cellar.

18. A method in accordance with claim 15 further comprising providing, on at least one of the first user device and the second user device, a reminder that a particular bottle has been reserved for removal from the cellar.

19. A method in accordance with claim 17 further comprising adding a bottle of wine to the inventory using the first user device.

20. A method in accordance with claim 15 further comprising providing confirmation to the server that the reserved bottle of wine has been removed from the cellar.
